(19) United States
(12) Patent Application Publication
(10) Pub. No.: US 2026/0360766 A1
(43) Pub. Date: Nov. 12, 2026

(54) METHOD OF MANUFACTURING CATALYST COMPOSITE FOR FUEL CELL AND CATALYST COMPOSITE MANUFACTURED USING SAME

(71) Applicants: Hyundai Motor Company, Seoul (KR); Kia Corporation, Seoul (KR); Inha University Research and Business Foundation, Incheon (KR)

(72) Inventors: Young Jung Heo, Hwaseong-si (KR); Hee Su Yang, Hwaseong-si (KR); Jong Kil Oh, Hwaseong-si (KR); Chang Bum Jo, Incheon (KR); Tae Hoon Kim, Incheon (KR); Yeon Jae Jo, Incheon (KR)

(73) Assignees: Hyundai Motor Company, Seoul (KR); Kia Corporation, Seoul (KR); Inha University Research and Business Foundation, Incheon (KR)

(21) Appl. No.: 19/392,882

(22) Filed: Nov. 18, 2025

(30) Foreign Application Priority Data
May 12, 2025 (KR) 10-2025-0061035

(51) Int. Cl. H01M 4/88; H01M 4/92

(52) U.S. Cl. CPC H01M 4/8846; H01M 4/8882; H01M 4/926

(57) ABSTRACT

A method is provided for making a fuel-cell catalyst composite by using a two-layer solvent. A metal catalyst precursor is dissolved in a first solvent and a second solvent that does not dissolve the precursor is added to form two layers. The two-layer solution is used to impregnate a porous support, the support is dried, and the precursor is reduced so that a metal catalyst is supported on the support. By adjusting the volume ratio of the first and second solvents, the average particle size and dispersion of the supported metal can be controlled. In preferred cases, the support includes mesopores with a mesopore utilization ratio of 50% to 80%, and at least 30.5% of the total supported metal resides inside the pores. The approach improves poisoning resistance and durability of fuel cells.

### CROSS-REFERENCE TO RELATED APPLICATION

This application claims, under 35 U.S.C. § 119(a), the benefit ofKorean Patent Application No. 10-2025-0061035, filed on May 12, 2025, the entire contents of which are incorporated herein by reference.

### BACKGROUND

### Technical Field

The present disclosure relates to a method of manufacturing a catalyst composite for a fuel cell and a catalyst composite manufactured using the same, and more particularly, to technology capable of controlling the dispersivity and size of a catalyst metal supported on a porous support.

### Background

An electrode catalyst layer, which is a component of a proton exchange membrane fuel cell (PEMFC), includes a carbon support on which a catalyst metal such as platinum, etc. is supported and an ionomer serving as a binder. In particular, a catalyst composite, which is a form in which metal catalyst particles used as a catalyst for a fuel cell are supported on a carbon support, plays the most important role in cell performance and durability, and performance of the catalyst composite is greatly affected by the structure and characteristics of the catalyst particles and carbon support. Therefore, the development of optimized catalysts to ensure the performance and durability of hydrogen electric vehicles is very urgent and important.

Specifically, in the catalyst for a fuel cell, the carbon support functions as an electron conductor that transfers electrons to catalyst particles and as a support that disperses catalyst nanoparticles into small particles to improve catalytic activity. In order to support metal catalyst particles on a carbon support, a method has been used conventionally in which a dissolved metal catalyst precursor is supported on a carbon support and then reduced using a polyol method.

However, this method is disadvantageous in that the catalyst particles supported on the carbon support are mainly located outside, and the proportion of the catalyst particles distributed inside pores is low, making it vulnerable to poisoning caused by the ionomer and deteriorating the durability and performance of the fuel cell.

### SUMMARY

The present disclosure has been made keeping in mind the problems encountered in the related art, and an embodiment of the present disclosure is to provide a method of manufacturing a catalyst composite in which the depth of penetration of catalyst particles into pores may be improved and an increase in pore utilization rate may be induced.

Another embodiment of the present disclosure is to provide a method of manufacturing a catalyst composite in which the particle size of catalyst particles supported on a porous support may be controlled and dispersivity is excellent.

The embodiments of the present disclosure are not limited to the foregoing. The embodiments of the present disclosure will be able to be clearly understood through the following description and to be realized by the features and embodiments described in the claims, illustrative examples, and combinations thereof.

In one aspect, a method of manufacturing a catalyst composite for a fuel cell is provided, the method comprising:
a) preparing a mixed solution component comprising i) a metal catalyst precursor, a first solvent component comprising one or more solvents and a second solvent component comprising one or more solvents, wherein the first solvent component exhibits greater solubility with the metal catalyst precursor than the second solvent component.
b) impregnating pores of a porous support with the mixed solution;
c) reducing the metal catalyst precursor to provide a catalyst composite comprising a metal catalyst supported on the porous support.

In aspects of the method, a precursor solution may be prepared by dissolving a metal catalyst precursor in a first solvent component comprising one or more solvents, and the forming the mixed solution by adding a second solvent component comprising one or more solvent to the precursor solution.

An embodiment of the present disclosure provides a method of manufacturing a catalyst composite for a fuel cell, including preparing a precursor solution by dissolving a metal catalyst precursor in a first solvent, forming a two-layer solution by adding a second solvent to the precursor solution, impregnating pores of a porous support with the two-layer solution, drying the porous support impregnated with the two-layer solution, and manufacturing a catalyst composite in which a metal catalyst is supported on the porous support by reducing the metal catalyst precursor.

In one embodiment, the first solvent may include a solvent capable of dissolving or dispersing the metal catalyst precursor.

In one embodiment, the first solvent may include at least one of acetonitrile, isopropyl alcohol, acetyl acetate, DI water, acetone, tetrahydrofuran (THF), or diethyl ether.

In one embodiment, the metal catalyst precursor may include a precursor of a metal catalyst including at least one of platinum (Pt) or a platinum alloy (Pt-M).

In one embodiment, the metal catalyst precursor may include at least one of chloroplatinic acid, platinum acetylacetonate, platinum chloride, platinum bromide, or platinum iodide.

In one embodiment, the second solvent may include a solvent incapable of dissolving the metal catalyst precursor.

In one embodiment, the second solvent may include at least one of hexane, benzene, ethyl acetate, or toluene.

In one embodiment, an average particle size of the metal catalyst supported on the porous support may be controlled by adjusting a volume ratio of the first solvent to the second solvent.

In one embodiment, a sum (V₁₊₂) of a volume (V₁) of the first solvent in the precursor solution and a volume (V₂) of the second solvent added to the precursor solution may satisfy 0.8 to 1.2 times a pore volume (Vₛ) of the porous support.

In one embodiment, preparing the precursor solution, forming the two-layer solution, impregnating with the two-layer solution, and drying the porous support may be performed at least twice.

In one embodiment, the pores in the porous support may be impregnated with the two-layer solution using an incipient wetness impregnation method.

In one embodiment, the metal catalyst precursor may be reduced by heat treatment in a reducing atmosphere.

In one embodiment, the porous support may include mesopores, and a mesopore utilization rate of the porous support on which the metal catalyst is supported may be 50% to 80%.

In one embodiment, a proportion of the metal catalyst supported inside the porous support based on the total amount of metal catalyst may be 30.5% or more.

Another embodiment of the present disclosure provides a catalyst composite for a fuel cell, including a porous support including mesopores and a metal catalyst supported on the porous support, in which a mesopore utilization rate of the porous support is 50% to 80%.

In one embodiment, a proportion of the metal catalyst supported inside the porous support based on the total amount of metal catalyst may be 30.5% or more.

In one embodiment, a proportion of the mesopores based on the total pores in the porous support may be 50% or more.

In one embodiment, the porous support may include a carbon support, a metal organic framework, a mesoporous metal oxide, or a porous polymer, and the carbon support may include at least one of carbon black, carbon nanotubes, graphite, or graphene.

In one embodiment, the metal catalyst may include at least one of platinum (Pt) or a platinum alloy (Pt-M).

In one embodiment, the platinum alloy (Pt-M) may include an alloy of platinum and metal including at least one of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), or bismuth (Bi).

As discussed, the method and system suitably include use of a controller or processer.

In another embodiment, vehicles are provided that comprise an apparatus as disclosed herein.

### BRIEF DESCRIPTION OF THE DRAWINGS

Various embodiments, and features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a photograph showing two layers of a precursor solution and benzene formed after a dispersion process during manufacture of a catalyst composite according to Example 1;

FIG. 2 is a photograph showing two layers of a precursor solution and benzene formed after the dispersion process during manufacture of a catalyst composite according to Example 2;

FIG. 3 is a photograph showing a single layer of a mixture of a precursor solution and water formed after the dispersion process during manufacture of a catalyst composite according to Comparative Example 3;

FIG. 4 is a graph showing the average particle sizes of metal catalysts supported on catalyst composites synthesized by changing the type and mixing proportion of the solvent used;

FIG. 5 is a graph showing results of XRD analysis of catalyst composites synthesized by changing the type and mixing proportion of the solvent used;

FIG. 6 shows results of XRD peak analysis of Example 1;

FIG. 7 shows results of XRD peak analysis of Example 2, Comparative Example 2, and Comparative Example 3;

FIG. 8 shows results of transmission electron microscopy (TEM) of the catalyst composite according to Example 2;

FIG. 9 shows results of transmission electron microscopy (TEM) of the catalyst composite according to Comparative Example 2;

FIG. 10 shows results of transmission electron microscopy (TEM) of the catalyst composite according to Comparative Example 3;

FIG. 11 shows scanning transmission electron microscope (STEM) and secondary electron (SE) images of the catalyst composite according to Example 1, in which the metal catalyst particles supported on the outside of the support and the metal catalyst particles supported inside the pores are represented;

FIG. 12 shows scanning transmission electron microscope (STEM) and secondary electron (SE) images of the catalyst composite according to Comparative Example 4, in which the metal catalyst particles supported on the outside of the support and the metal catalyst particles supported inside the pores are represented;

FIG. 13 shows results of small angle neutron scattering (SANS) analysis of the catalyst composite according to Example 1 and the catalyst composite according to Comparative Example 4;

FIG. 14 shows charge/discharge results of membrane-electrode assemblies to which the catalyst composites according to Example 1 and Comparative Example 4 are applied under low temperature/high humidity conditions; and

FIG. 15 shows charge/discharge results of membrane-electrode assemblies to which the catalyst composites according to Example 1 and Comparative Example 4 are applied under high temperature/low humidity conditions.

### DETAILED DESCRIPTION

The above and other embodiments, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

In addition, “vehicle” or “automobile” or other similar terms used herein are understood to include general automobiles such as sport utility vehicles (SUVs), buses, trucks, various commercial vehicles, etc., and transportation means such as trains, ships, and aircraft, and also include hybrid vehicles, electric vehicles, plug-in hybrid electric vehicles, hydrogen-powered vehicles, and other alternative fuel vehicles (e.g., fuel derived from resources other than petroleum). “Hybrid vehicle” as used herein means a vehicle that has two or more power sources (e.g., a gasoline-powered vehicle and an electric-powered vehicle).

As used herein, “two-layer solution” refers to a mixed liquid in which the precursor solution containing the metal catalyst precursor dissolved in the first solvent and the second solvent coexist as two immiscible layers under processing or observation conditions.

As used herein, “mesopore utilization rate” refers to the proportion of mesopore volume of the porous support that is available for and utilized in supporting the metal catalyst, as determined from small-angle neutron scattering (SANS) analysis described in the specification.

As used herein “proportion of metal catalyst supported inside the pores” (also “internal support proportion”) refers to the percentage of the total supported metal catalyst that is located within pores of the support, determined by comparing particle counts of the same area measured using STEM and SE-STEM or by comparable means.

As used herein “incipient wetness impregnation method” refers to impregnation in which the total liquid volume added is approximately equal to the pore volume of the porous support such that the solution is taken up by capillary action without bulk liquid remaining. As used herein, “solution” means any composition in which at least one component is distributed within a continuous phase and includes, without limitation, i) true molecular or ionic solutions; and ii) dispersions such as colloids, emulsions, micro-/nano-emulsions, and suspensions of two or more components.

In general, methods of supporting a metal catalyst on a support are divided into polyol methods using a polyol solvent as a reducing agent and impregnation methods in which a metal catalyst precursor solution penetrates the support and is then supported through drying and heat treatment. The impregnation methods may be subdivided into wet impregnation methods in which a catalyst is manufactured by mixing a precursor solution and a support, removing the solvent, and performing a calcination process, and incipient wetness impregnation methods in which a catalyst is manufactured by dissolving a precursor in a solvent equal to the pore volume of the support and adding the same to the support followed by drying and calcination.

Conventional polyol and impregnation methods mainly support the catalyst on the surface of the support, leaving it vulnerable to ionomer-induced poisoning, providing low dispersion, and making particle-size control difficult.

The present disclosure is intended to solve such problems and relates to a method of supporting a metal catalyst on a support using a two-layer solvent method, and a catalyst composite manufactured using the same.

Specifically, a method of manufacturing a catalyst composite for a fuel cell according to an embodiment of the present disclosure may include preparing a precursor solution by dissolving a metal catalyst precursor in a first solvent, forming a two-layer solution by adding a second solvent to the precursor solution, impregnating pores of a porous support with the two-layer solution, drying the porous support impregnated with the two-layer solution, and manufacturing a catalyst composite in which a metal catalyst is supported on the porous support by reducing the metal catalyst precursor.

In one embodiment, the first solvent may include a solvent capable of dissolving the metal catalyst precursor. As used herein, “capable of dissolving a metal catalyst precursor” means that dissolution is maintained under temperatures and pressures used to manufacture the catalyst composite, which may be verified by visual observation or equivalent methods.

The first solvent may be used without particular limitation so long as it is capable of dissolving the metal catalyst precursor, and in one embodiment, the first solvent may include at least one of acetonitrile, isopropyl alcohol, acetyl acetate, deionized (DI) water, acetone, tetrahydrofuran (THF), or diethyl ether.

In one embodiment, the metal catalyst supported on the porous support may include at least one of platinum (Pt) or a platinum alloy (Pt-M). As a non-limiting example, the platinum alloy (Pt-M) may include an alloy of platinum and metal including at least one of chromium (Cr), manganese (Mn), iron (Fe), cobalt (Co), nickel (Ni), copper (Cu), zinc (Zn), gallium (Ga), yttrium (Y), zirconium (Zr), niobium (Nb), molybdenum (Mo), ruthenium (Ru), indium (In), tin (Sn), tungsten (W), iridium (Ir), gold (Au), or bismuth (Bi).

In one embodiment, the metal catalyst precursor added to the first solvent is a precursor of a metal catalyst supported on a porous support, and specifically, the metal catalyst precursor may include a precursor of a metal catalyst including at least one of platinum (Pt) or a platinum alloy (Pt-M). As a non-limiting example, the metal catalyst precursor may include at least one of chloroplatinic acid, platinum acetylacetonate, platinum chloride, platinum bromide, or platinum iodide.

Here, the metal catalyst precursor “including a precursor of a metal catalyst including a platinum alloy” may be understood to mean that a precursor including platinum and a precursor including a metal (M) that forms an alloy with platinum are added to the first solvent in preparation for a subsequent process. Alternatively, it may be understood that a metal catalyst including platinum is supported on a porous support using a two-layer solution method and then the porous support on which the metal catalyst including platinum is supported and a precursor including the metal (M) are added to the first solvent in preparation for a subsequent process.

According to an embodiment of the present disclosure, a two-layer solution may be formed by adding and dissolving the metal catalyst precursor to and in the first solvent to prepare a precursor solution and adding a second solvent to the precursor solution.

Any one layer of the two-layer solution may include the precursor solution in which the metal catalyst precursor is dissolved in the first solvent, and the remaining layer may include the second solvent.

In one embodiment, the second solvent may be a solvent incapable of dissolving the metal catalyst precursor. Here, “second solvent incapable of dissolving the metal catalyst precursor” means not only that the metal catalyst precursor added to the second solvent does not dissolve at all under temperature and pressure conditions encountered in the process of manufacturing the catalyst composite, but also that the state of dispersion of the metal catalyst precursor in the second solvent may be maintained long due to low solubility. Whether the state in which the metal catalyst precursor does not dissolve but is dispersed may be maintained may be determined by methods such as visual observation, etc.

The second solvent may be used without particular limitation so long as it is unable to dissolve the metal catalyst precursor, and in one embodiment, the second solvent may include at least one of hexane, benzene, ethyl acetate, or toluene.

As in an embodiment of the present disclosure, a two-layer solution may be prepared using the first solvent capable of dissolving the metal catalyst precursor and the second solvent incapable of dissolving the metal catalyst precursor.

In one embodiment, the average particle diameter of the metal catalyst supported on the porous support may be controlled by adjusting the volume ratio of the first solvent to the second solvent. According to an embodiment of the present disclosure, by adjusting the volume ratio while considering solubility, wettability, boiling point, etc. of the first and second solvents used, the average particle diameter of the metal catalyst supported on the porous support may be reduced and controlled to a desired size.

According to an embodiment of the present disclosure, a two-layer solution may be prepared and the pores in the prepared porous support may be impregnated with the two-layer solution. As such, the method of impregnating the pores in the porous support with the two-layer solution is not particularly limited, but preferably, an incipient wetness impregnation method is used to impregnate the pores in the porous support with the two-layer solution.

For example, the prepared porous support may be placed in a container (e.g., a mortar), and the prepared precursor solution may be added dropwise to the porous support using a micro syringe and ground using a pestle. In this process, the pores in the porous support may be impregnated with the two-layer solution, and the ground porous support may also be collected using a tool such as a spatula, etc. The grinding to impregnation process may be repeated until the synthesized two-layer solution is completely used and the prepared porous support is present in a dry powder state.

Also, in order to more efficiently impregnate the pores in the porous support with the two-layer solution using an incipient wetness impregnation method, the amounts of the first and second solvents may be limited to appropriate ranges based on the pore volume of the porous support. In one embodiment, the sum (V₁₊₂) of the volume (V₁) of the first solvent included in the precursor solution and the volume (V₂) of the second solvent added to the precursor solution may satisfy 0.8 to 1.2 times the pore volume (Vₛ) of the porous support. In theory, it is desirable that the sum (V₁₊₂) of the volume (V₁) of the first solvent and the volume (V₂) of the second solvent be equal to the pore volume (Vₛ) of the porous support, but in practice, taking into account an increase in the volume of the solvent due to the metal catalyst precursor, the sum of the volumes of the solvents may satisfy 0.8 to 1.2 times the pore volume (Vₛ) of the porous support.

According to an embodiment of the present disclosure, the pores in the porous support may be impregnated with the two-layer solution, and the porous support impregnated with the two-layer solution may be dried. Under drying conditions, the drying time and temperature may be applied without particular limitation so long as the first solvent and the second solvent in the two-layer solution with which the pores in the porous support are impregnated may be removed and the metal catalyst precursor may remain.

Also, an incipient wetness impregnation method may be sequentially applied to locate the metal catalyst precursor in the pores in the porous support more efficiently. In one embodiment, preparing the precursor solution, forming the two-layer solution, impregnating with the two-layer solution, and drying the porous support may be performed at least twice.

For example, preparing a precursor solution by dissolving half of the prepared metal catalyst precursor in the first solvent, forming a two-layer solution by mixing the precursor solution in which half of the metal catalyst precursor is dissolved with the second solvent, impregnating the pores in the porous support with the two-layer solution, and drying the porous support are performed. Subsequently, preparing a precursor solution by dissolving the remaining half of the metal catalyst precursor in the first solvent, forming a two-layer solution by mixing the precursor solution in which the remaining half of the metal catalyst precursor is dissolved with the second solvent, impregnating the pores in the porous support on which half of the metal catalyst precursor is supported with the two-layer solution, and drying the porous support may be performed.

According to an embodiment of the present disclosure, the metal catalyst precursor may be supported in the pores in the porous support, and the metal catalyst precursor may be reduced by heat treatment in a reducing atmosphere. The method of forming a reducing atmosphere is not particularly limited, and for example, a reducing atmosphere may be formed by injecting a reducing gas containing nitrogen and hydrogen mixed in an appropriate ratio, for example, 9:1, into the reactor. In addition, the heat treatment time and temperature are not particularly limited so long as the metal catalyst precursor may be reduced into the metal catalyst, and for example, heat treatment may be performed at 200 °C to 400 °C for 1 hour to 3 hours.

According to an embodiment of the present disclosure, by reducing the metal catalyst precursor supported in the pores in the porous support by heat treatment, a catalyst composite for a fuel cell in which the metal catalyst is supported on the porous support may be obtained.

According to various embodiments of the present disclosure, by supporting the metal catalyst on the porous support using a two-layer solvent method, the depth of penetration of the metal catalyst into pores may be improved and an increase in the pore utilization rate may be induced.

In one embodiment, the porous support may include a support commonly used in the field of fuel cells, and examples of the porous support may include a carbon support, a metal organic framework, a mesoporous metal oxide, and a porous polymer. More specifically, the carbon support may include at least one of carbon black, carbon nanotubes, graphite, or graphene. The mesoporous metal oxide may include Al₂O₃, SnO₂, TiO₂, etc.

In one embodiment, the porous support may include mesopores. Here, mesopores indicate pores having a size of 5 nm to 50 nm, particularly pores having a size of 5 nm to 15 nm. Also, a porous support having 50% or more of mesopores based on the total pores in the porous support may be used. If the pore size is smaller than the particle size of the metal catalyst supported on the porous support, it is difficult to support the metal catalyst in the pores, making it difficult to expect effects of preventing catalyst poisoning and improving dispersibility. On the other hand, if the pore size is too large, the ionomer may penetrate the pores, so the anti-poisoning effect may be lower than expected. In addition, if the proportion of mesopores based on the total pores in the porous support is less than 50%, the mesopore selectivity of the solvent may decrease, making it difficult to obtain desired effects.

In one embodiment, the mesopore utilization rate of the porous support on which the metal catalyst is supported may be 50% to 80%. Here, the mesopore utilization rate may be calculated by the following equation based on results of small angle neutron scattering (SANS) analysis of the synthesized catalyst composite.

$$Mesoporeutilization rate ( \% ) = ( \frac{1 - porosity}{{porosity}_{carbon}} ) \times 100$$

The catalyst composite according to an embodiment of the present disclosure has an excellent effect of preventing poisoning of a catalyst metal caused by an ionomer because the mesopore utilization rate of the porous support is as high as 50% or more, and thus the performance and durability of a fuel cell may be improved.

In one embodiment, the proportion of the metal catalyst supported inside the porous support based on the total metal catalyst may be 30.5% or more, for example 40% or more, for example 45% or more. Also, the upper limit of the internal supporting proportion of the metal catalyst may be, for example, 80% or less, for example 70% or less. If the internal supporting proportion of the metal catalyst exceeds 80%, catalytic reactivity may deteriorate.

The catalyst composite according to an embodiment of the present disclosure may have a high proportion of the metal catalyst supported inside the porous support, namely in the pores, compared to a catalyst composite synthesized by a conventional polyol method or an incipient wetness impregnation method using a single-layer solvent. In addition, according to one embodiment, the penetration depth of the metal catalyst supported on the porous support and the pore utilization rate may be increased, thereby improving the performance and durability of the fuel cell.

Here, the proportion of the metal catalyst supported inside the porous support may indicate the proportion of the metal catalyst located in the pores in the porous support based on the total metal catalyst supported on the porous support.

For example, a certain area of the catalyst composite according to an embodiment of the present disclosure is imaged using a scanning transmission electron microscope (STEM) to measure the total number of particles of the metal catalyst supported on the porous support. In addition, the front and back of the catalyst composite located in the same area are imaged using SE (secondary electron)-STEM, and the metal catalyst particles observed from the SE-STEM images are regarded as the metal catalyst supported on the surface of the porous support.

By subtracting the number of metal catalyst particles observed from the SE-STEM results from the number of metal catalyst particles observed from the STEM results, the number of metal catalysts supported inside the porous support may be calculated.

In one embodiment, the average particle size (D50) of the metal catalyst supported on the porous support may be 1 nm to 10 nm, 1 nm to 5 nm, or 2 nm to 3.7 nm. According to an embodiment of the present disclosure, the metal catalyst having a small particle size compared to a conventional polyol method or an incipient wetness impregnation method using a single-layer solvent may be supported on the porous support.

A better understanding of the present disclosure may be obtained through the following examples and comparative examples. However, these examples are not to be construed as limiting the technical spirit of the present disclosure.

### Example 1—ACN+Benzene

The pore volume of carbon black (70% mesopores having a size of 50 nm or less) prepared as a carbon support was measured under vacuum conditions at about 300 °C using a known nitrogen adsorption method. As such, the relative pressure of nitrogen (p/p₀) was 0.95.

Acetonitrile in a volume corresponding to approximately half of the pore volume (Vₛ) of the carbon support measured was placed in a conical tube, and half of 0.0572 g of chloroplatinic acid (H₂PtCl₆·6H₂O) was dissolved in the acetonitrile to support 30 wt % of a platinum catalyst on the carbon support to prepare a precursor solution.

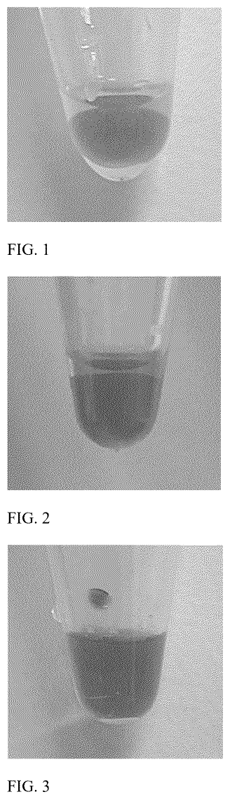

Benzene in a volume corresponding to approximately half of the pore volume (Vs) of the carbon support was placed in the conical tube and then sufficiently dispersed using a sonicator. FIG. 1 shows a photograph of two layers of the precursor solution and benzene formed after the dispersion process.

After placing 0.05 g of the prepared carbon support in a mortar, the two-layer solution formed above was evenly added dropwise using a syringe and simultaneously ground using a pestle. The prepared two-layer solution was completely added dropwise and the grinding process continued until the carbon support was present in an initial dry powder state.

The carbon support impregnated with the two-layer solution was transferred to a polypropylene container, and dried in an oven at about 50 °C for 1 hour with the lid closed, and then dried for 2 hours with the lid open.

Next, the carbon support was impregnated with the remaining half of 0.0572 g of chloroplatinic acid (H₂PtCl₆·6H₂O) prepared through the same process as above.

After a drying process, the carbon support, pores in which were impregnated with the platinum precursor, was placed in a vertical reactor, 10% H₂ gas was injected into the vertical reactor at a flow rate of 30 ml/min, and the temperature was raised to about 300 °C for 4 hours and then maintained for 2 hours to reduce the platinum precursor.

Thereafter, the vertical reactor was purged with nitrogen for 30 minutes, and then the bottom of the vertical reactor was left open for 1 hour, thereby stabilizing the synthesized catalyst composite.

### Example 2—IPA+Benzene

A catalyst composite was manufactured through the same process as in Example 1, with the exception that isopropyl alcohol (IPA) was used instead of acetonitrile. The two layers of the precursor solution and benzene formed after the dispersion process in manufacturing the catalyst composite according to Example 2 are shown in FIG. 2.

### Comparative Example 1—ACN

The pore volume of carbon black (70% mesopores having a size of 50 nm or less) prepared as a carbon support was measured under vacuum conditions at about 300 °C using a known nitrogen adsorption method. As such, the relative pressure of nitrogen (p/p₀) was 0.95.

Acetonitrile in a volume corresponding to the pore volume (Vₛ) of the carbon support measured was placed in a conical tube, and 0.0572 g of chloroplatinic acid (H₂PtCl₆·6H₂O) was dissolved in the acetonitrile to prepare a precursor solution.

After placing 0.05 g of the prepared carbon support in a mortar, the precursor solution was evenly added dropwise using a syringe and simultaneously ground using a pestle. The prepared precursor solution was completely added dropwise and the grinding process continued until the carbon support was present in an initial dry powder state.

The carbon support impregnated with the precursor solution was transferred to a polypropylene container, and dried in an oven at about 50 °C for 1 hour with the lid closed, and then dried for 2 hours with the lid open.

After a drying process, the carbon support, pores in which were impregnated with the platinum precursor, was placed in a vertical reactor, 10% H₂ gas was injected into the vertical reactor at a flow rate of 30 ml/min, and the temperature was raised to about 300 °C for 4 hours and then maintained for 2 hours to reduce the platinum precursor.

Thereafter, the vertical reactor was purged with nitrogen for 30 minutes, and then the bottom of the vertical reactor was left open for 1 hour, thereby stabilizing the synthesized catalyst composite.

### Comparative Example 2—IPA

A catalyst composite was manufactured through the same process as in Comparative Example 1, with the exception that isopropyl alcohol (IPA) was used instead of acetonitrile.

### Comparative Example 3—IPA+Water

A catalyst composite was manufactured through the same process as in Example 1, with the exception that isopropyl alcohol (IPA) was used instead of acetonitrile, water was used instead of benzene, and a single layer was formed rather than two layers. FIG. 3 shows a photograph of a single layer of a mixture of the precursor solution and water formed after the dispersion process.

### Comparative Example 4—EG

A platinum catalyst was supported on a carbon support using a known polyol method. Specifically, a precursor solution was formed by dissolving chloroplatinic acid (H₂PtCl₆·6H₂O) in ethylene glycol (EG) as a polyol solvent, and then the same carbon support prepared in Example 1 was added to the precursor solution. Thereafter, the precursor solution in which the carbon support was dispersed was heated with stirring to reduce the precursor. Thereafter, a catalyst composite was obtained through a drying process.

### Test Example 1—XRD Analysis

In order to determine how the average particle size of the metal catalyst changes depending on the type and mixing proportion of the solvent used based on acetonitrile serving as the first solvent, XRD analysis was performed on the catalyst composites synthesized under various conditions, and the average particle size was graphed based on the analysis results.

Specifically, XRD analysis was performed on catalyst composites synthesized by manufacturing the catalyst composite according to Example 1 but adjusting the volume ratio of acetonitrile to benzene to 1:1, 1:1.5, and 1:2, and on catalyst composites synthesized by using hexane instead of benzene and adjusting the volume ratio of acetonitrile to hexane to 1:1, 1:1.5, and 1:2. Also, XRD analysis was performed on the catalyst composite synthesized according to Comparative Example 1. For reference, the sharper the XRD peak, the larger the particle size.

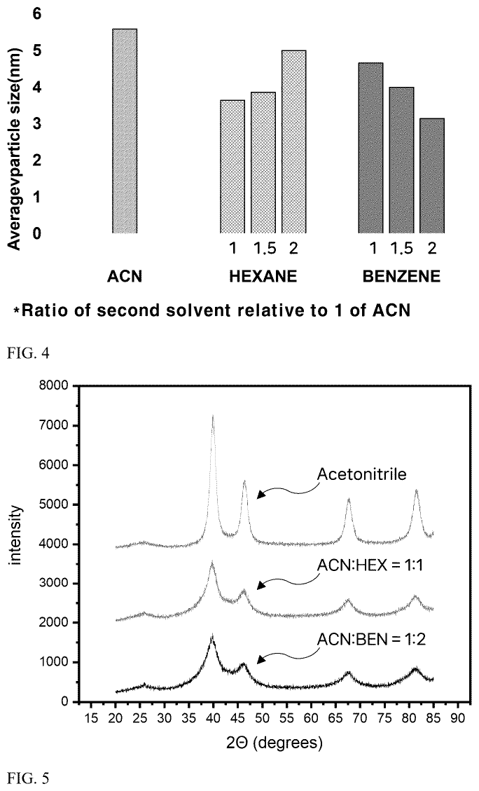

The results of the average particle size of the metal catalyst particles determined based on the XRD results are shown in FIG. 4, and the XRD results, in which acetonitrile was used alone as the solvent, acetonitrile and benzene were used in a volume ratio of 1:2, and acetonitrile and hexane were used in a volume ratio of 1:1, are shown in FIG. 5.

Referring to the results of FIGS. 4 and 5, the catalyst composite manufactured by the two-layer solution method with the addition of benzene or hexane exhibited a small metal catalyst size compared to the use of a single solvent. As such, it was confirmed that the particle size of the metal catalyst was controllable by adjusting the ratio of the first solvent to the second solvent.

### Test Example 2—XRD Analysis

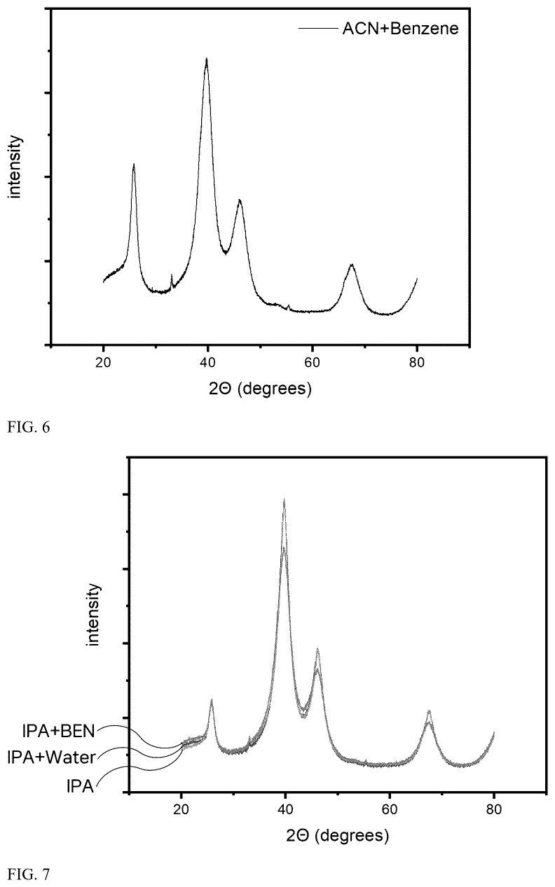

XRD peak analysis was performed on Example 1, Example 2, and Comparative Examples 1 to 3 to analyze the particle size of the manufactured catalyst composite. The results of XRD peak analysis of Example 1 are shown in FIG. 6, and the results of XRD peak analysis of Example 2, Comparative Example 2, and Comparative Example 3 are shown in FIG. 7. In addition, the average particle size was determined based on the results of FIGS. 6 and 7 and is shown in Table 1 below.

TABLE 1

| | | Average particle |
|---|---|---|
| Classification | Solvent | size (nm) |
| Example 1 | ACN + benzene | 3.26 |
| Example 2 | IPA + benzene | 3.11 |
| Comparative Example 1 | ACN alone | 5.58 |
| Comparative Example 2 | IPA alone | 3.73 |
| Comparative Example 3 | IPA + water | 3.76 |

Referring to the results in FIGS. 6 and 7 and Table 1, the average particle size was smaller in Examples 1 and 2 using two solvents than in Comparative Examples 1 and 2 using a single solvent. Also, there was no particle size reduction effect in Comparative Example 3 in which two solvents were used but two layers were not formed. Therefore, the effect of reducing the particle size of the metal catalyst supported on the carbon support was confirmed only in the presence of the two layers formed using a solvent having high ability to dissolve the metal catalyst precursor (e.g., ACN, IPA, etc.) and a solvent having low ability to dissolve the metal catalyst precursor (e.g., benzene, hexane, etc.).

### Test Example 3—TEM

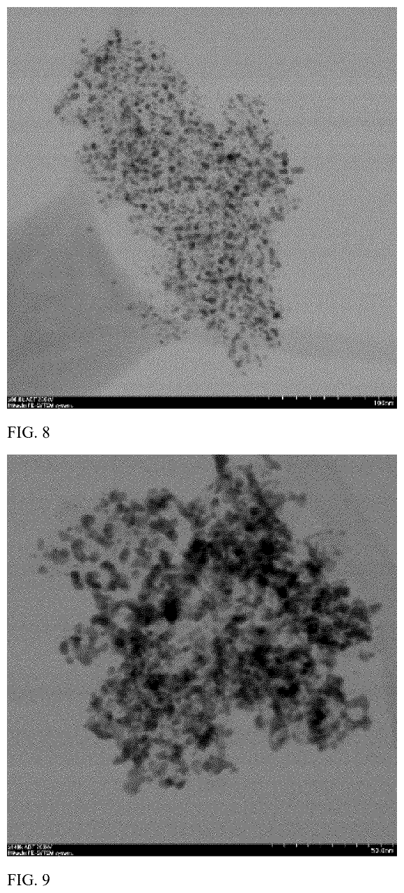

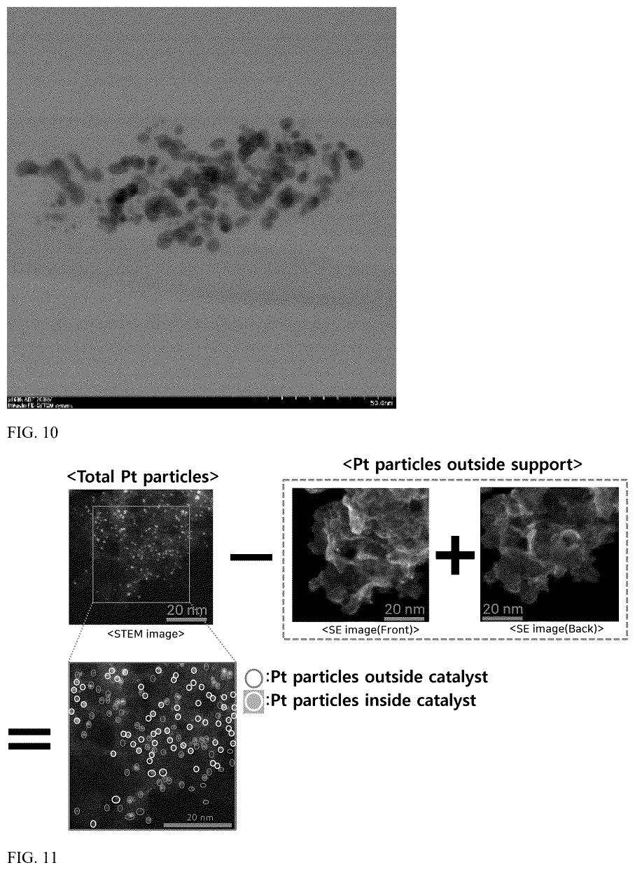

The approximate particle size of the metal catalyst, dispersivity, and supporting proportion in pores were determined based on results of transmission electron microscopy (TEM) of the catalyst composites synthesized according to Examples and Comparative Examples. For convenience of comparison, respective TEM results of the catalyst composites according to Example 2, Comparative Example 2, and Comparative Example 3 using IPA as the first solvent are shown in FIGS. 8 to 10.

Referring to FIGS. 8 to 10, in Example 2 in which the two-layer solution was formed during manufacture of the catalyst composite, the metal catalyst particles were confirmed to have a small particle size, excellent dispersivity, and high supporting proportion in the pores. Also, in Comparative Example 2 using a single solvent and Comparative Example 3 in which two solvents were used but two layers was not observed, the metal catalyst particles were confirmed to have a large particle size, low dispersivity, and low supporting proportion in the pores.

### Test Example 4—Supporting Proportion in Pores

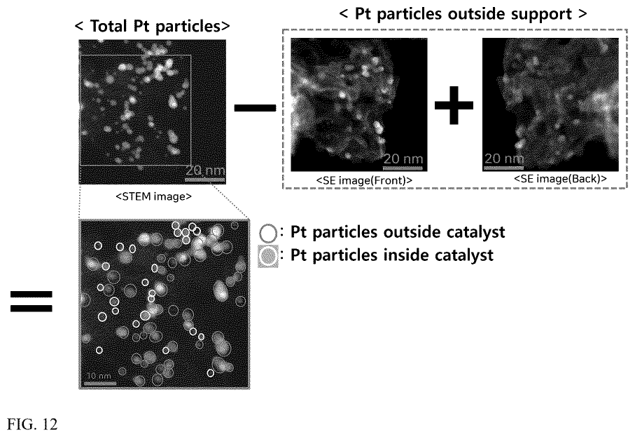

In order to confirm the location of the metal catalyst supported on the catalyst composite manufactured according to the present disclosure and the catalyst composite manufactured according to the conventional polyol method, the catalyst composite according to Example 1 and the catalyst composite according to Comparative Example 4 were observed using scanning transmission electron microscopy (STEM). In addition, the front and back of the catalyst composite located in the same area were observed using secondary electron (SE)-STEM. The difference between the number of metal catalyst particles observed from the STEM results and the number of metal catalyst particles observed from the SE-STEM results was calculated. The results of Example 1 are shown in FIG. 11, and the results of Comparative Example 4 are shown in FIG. 12.

For reference, the number of metal catalyst particles observed from the SE-STEM results corresponds to the platinum particles supported on the outside of the carbon support, and the value obtained by subtracting the number of metal catalyst particles observed from the SE-STEM results from the number of metal catalyst particles observed from the STEM results corresponds to the platinum particles supported inside the pores in the carbon support.

Referring to FIG. 11, 73 platinum particles supported on the outside of the support and 66 platinum particles supported inside the pores were confirmed and converted into percentages, so the external supporting proportion was 52.6% and the internal supporting proportion was 47.4%. Also, the average particle size of the catalyst metal confirmed in FIG. 12 was about 2.3 nm.

Also, referring to FIG. 12, 55 platinum particles supported on the outside of the support and 24 platinum particles supported inside the pores were confirmed and converted into percentages, so the external supporting proportion was 69.6% and the internal supporting proportion was 30.4%. Therefore, the internal supporting proportion of the metal catalyst was 30.5%, for example 40% or more, for example 45% or more. Also, the upper limit of the internal supporting proportion of the metal catalyst was, for example, 80% or less, for example 70% or less. If the internal supporting proportion of the metal catalyst exceeds 80%, reactivity of the catalyst may deteriorate.

According to the results of FIGS. 11 and 12, it was confirmed that the pore utilization rate and dispersivity of the catalyst composite manufactured using the two-layer solvent method were higher than the pore utilization rate and dispersivity of the catalyst composite manufactured using the conventional polyol method.

### Test Example 5—Mesopore Utilization Rate

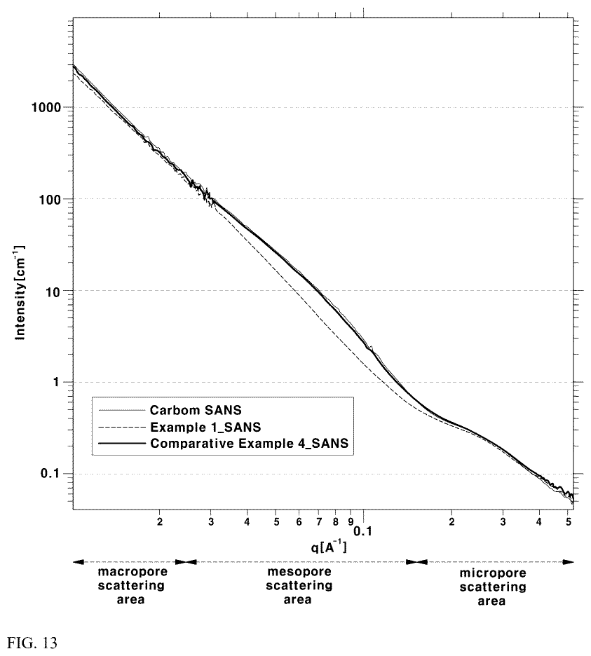

In order to confirm the mesopore utilization rate of the catalyst composite manufactured according to the present disclosure and the catalyst composite manufactured using the conventional polyol method, small angle neutron scattering (SANS) analysis was performed on the catalyst composite according to Example 1 and the catalyst composite according to Comparative Example 4, and the results are shown in FIG. 13. Also, the results of SANS analysis of a carbon support as a control are shown. Moreover, the mesopore utilization rate was calculated using the following equation and is shown in Table 2 below.

$$Mesoporeutilization rate ( \% ) = ( \frac{1 - porosity}{{porosity}_{carbon}} ) \times 100$$

TABLE 2

| Classification | Mesopore utilization rate |
|---|---|
| Example 1 | 55% |
| Comparative Example 4 | 20% |

Referring to the results in FIG. 13 and Table 2, the conventional carbon support and Comparative Example 4 exhibited almost the same pore distribution. In addition, Example 1 showed an increase in pore size and a decrease in porosity compared to the carbon support and Comparative Example 4, and introduction of the platinum catalyst particles into the mesopores in the support was confirmed based on a decrease in scattering in the mesopore area. Moreover, the mesopore utilization rate of the catalyst composite manufactured using the two-layer solvent method according to an embodiment of the present disclosure was higher than the mesopore utilization rate of the catalyst composite manufactured using the conventional polyol method.

### Manufacture of Membrane-Electrode Assembly

To verify the performance of the manufactured catalyst composite, a membrane-electrode assembly was manufactured using the following method. For reference, the same method as Example 1 was performed, but the amount of the catalytic metal supported on the carbon support was set to 40 wt %, and similarly, the same method as Comparative Example 4 was performed, but the amount of the catalytic metal supported on the carbon support was set to 40 wt %.

Specifically, a cathode slurry was prepared by adding the catalyst composite according to Example and Nafion (D2021) as an electrode binder to a mixed solvent of 100 g of NPA (n-propyl alcohol) and 100 g of water. As such, the weight ratio of the catalyst to the electrode binder was set so that the weight of the carbon support of the catalyst composite and the weight of the Nafion were 1:0.8.

In addition, an anode slurry was prepared by adding a known Pt/C catalyst and Nafion (D2021) as an electrode binder to the mixed solvent. As such, the weight ratio of the Pt/C catalys to the electrode binder was set so that the weight of the carbon support of the Pt/C catalyst and the weight of the Nafion were 1:1.

The cathode slurry was applied onto one side of a known Nafion (211) electrolyte membrane, and the anode slurry was applied onto the remaining side, followed by drying and heat treatment, thereby manufacturing a membrane-electrode assembly including a cathode (oxygen electrode), an anode (hydrogen electrode), and an electrolyte membrane disposed between the cathode and the anode. As such, the catalyst loading on the cathode was set to 0.15 mgPt/cm², and the catalyst loading on the anode was set to 0.05 mgPt/cm².

A membrane-electrode assembly was manufactured by applying the catalyst composite according to Comparative Example 4 to the cathode in the same manner as above.

### Test Example 6—Verification of Electrochemical Performance and Evaluation of Durability

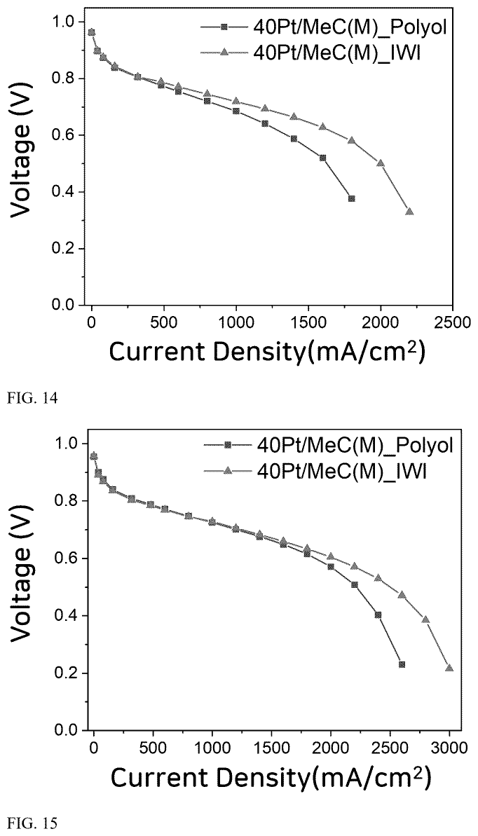

In order to verify the electrochemical performance of the membrane-electrode assembly to which the catalyst composite according to each of Example 1 and Comparative Example 4 was applied, charge/discharge testing was performed from a low current density (0 A/cm²) to a high current density (about 2.5 A/cm² to 3 A/cm²) in a manner in which the current was kept constant and the voltage when the voltage was stabilized was recorded. The voltage-current curves under conditions of low temperature and high humidity are shown in FIG. 14, and the results under conditions of high temperature and low humidity are shown in FIG. 15.

Here, low temperature and high temperature mean that the testing was performed at relatively low temperature and high temperature in the temperature range of room temperature to 100 °C, and low humidity and high humidity mean that the testing was performed under relatively low humidity and high humidity conditions in the relative humidity range of 0% to 100%.

Also, in order to verify the durability of the membrane-electrode assembly, the manufactured membrane-electrode assembly was fastened under a pressure of 100 in*lb using a gasket made of Teflon and a bipolar plate made of carbon to manufacture a unit cell, followed by an accelerated degradation test (ADT) under the following conditions, and the performance degradation rate at 1 A is shown in Table 3 below.

The ADT conditions are 0.6 V-0.95 V square wave, 3 seconds, 10,000 times; AN:H₂ 42 sccm CA:N₂ 134 sccm.

TABLE 3

| | Low temperature, | High temperature, |
|---|---|---|
| Classification | high humidity | low humidity |
| Example 1 | 22.2% | 10.9% |
| Comparative Example 4 | 48.9% | 19.6% |

Referring to the results of FIGS. 14 and 15, performance of the membrane-electrode assembly to which the catalyst composite synthesized according to an embodiment of the present disclosure was applied was superior to that of the membrane-electrode assembly to which the catalyst composite synthesized by the polyol method was applied, regardless of temperature and humidity. In view of durability, also, the performance degradation rate of the membrane-electrode assembly to which the catalyst composite according to the present disclosure was applied was very low.

This is deemed to be because the catalyst composite synthesized by the two-layer solvent method according to an embodiment of the present disclosure has a high proportion of the metal catalyst supported in the pores in the carbon support, particularly a high mesopore utilization rate, so that the effect of preventing poisoning caused by the ionomer is excellent, and the size of the metal catalyst supported on the support is small and the dispersivity is excellent.

As is apparent from the foregoing, according to an embodiment of the present disclosure, by supporting a metal catalyst on a porous support using solvents having different abilities to dissolve a metal catalyst precursor, the depth of penetration of the metal catalyst into the pores can be improved and an increase in the pore utilization rate can be induced.

In addition, a catalyst composite in which the particle size of the metal catalyst supported on the porous support is controlled and dispersivity is excellent can be manufactured.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A method of manufacturing a catalyst composite for a fuel cell is provided, the method comprising:
a) preparing a mixed solution component comprising i) a metal catalyst precursor, a first solvent component comprising one or more solvents and a second solvent component comprising one or more solvents, wherein the first solvent component exhibits greater solubility with the metal catalyst precursor than the second solvent component.
b) impregnating pores of a porous support with the mixed solution;
c) reducing the metal catalyst precursor to provide a catalyst composite comprising a metal catalyst supported on the porous support.

2. A method of manufacturing a catalyst composite for a fuel cell, the method comprising:
preparing a precursor solution by dissolving a metal catalyst precursor in a first solvent component comprising one or more solvents;
forming a mixed solution by adding a second solvent component comprising one or more solvent to the precursor solution;
impregnating pores of a porous support with the mixed solution; and
reducing the metal catalyst precursor to provide a catalyst composite comprising a metal catalyst supported on the porous support,
wherein the first solvent component exhibits greater solubility with the metal catalyst precursor than the second solvent component.

3. The method of claim 2, wherein the first solvent component has greater polarity than the second solvent component.

4. The method of claim 2, wherein the mixed solution exhibits phase separation.

5. The method of claim 2 further comprising drying the porous support with the mixed solution and thereafter reducing the metal catalyst precursor.

6. The method of claim 2, wherein the first solvent component comprises one or more solvents capable of dissolving the metal catalyst precursor.

7. The method of claim 2, wherein the first solvent component comprises at least one of acetonitrile, isopropyl alcohol, acetyl acetate, deionized water, acetone, tetrahydrofuran (THf), or diethyl ether.

8. The method of claim 2, wherein the metal catalyst precursor comprises a precursor of a metal catalyst comprising at least one selected from the group consisting of platinum (Pt) and a platinum alloy (Pt-M).

9. The method of claim 8, wherein the metal catalyst precursor comprises at least one of chloroplatinic acid, platinum acetylacetonate, platinum chloride, platinum bromide, or platinum iodide.

10. The method of claim 2, wherein the second solvent component comprises a solvent incapable of dissolving the metal catalyst precursor.

11. The method of claim 2, wherein the second solvent component comprises at least one of hexane, benzene, ethyl acetate, or toluene.

12. The method of claim 2, wherein an average particle size of the metal catalyst supported on the porous support is controlled by adjusting a volume ratio of the first solvent component to the second solvent component.

13. The method of claim 2, wherein a sum (V₁₊₂) of a volume (V₁) of the first solvent component in the precursor solution and a volume (V₂) of the second solvent component added to the precursor solution satisfies about 0.8 to 1.2 times a pore volume (Vₛ) of the porous support.

14. The method of claim 2, wherein preparing the precursor solution, forming the mixed solution, impregnating with the mixed solution, and drying the porous support are performed at least twice.

15. The method of claim 2, wherein the pores of the porous support are impregnated with the mixed solution using an incipient wetness impregnation method.

16. The method of claim 2, wherein the metal catalyst precursor is reduced by heat treatment in a reducing atmosphere.

17. The method of claim 2, wherein the porous support comprises mesopores, and a mesopore utilization rate of the porous support on which the metal catalyst is supported is about 50% to 80%.

18. The method of claim 2, wherein a proportion of the metal catalyst supported inside the porous support based on a total amount of metal catalyst is about 30.5% or more.

19. A catalyst composite for a fuel cell, the catalyst composite comprising:
a porous support comprising mesopores; and
a metal catalyst supported on the porous support,
wherein a mesopore utilization rate of the porous support is about 50% to 80%.

20. The catalyst composite of claim 19, wherein a proportion of the metal catalyst supported inside the porous support based on a total amount of metal catalyst is about 30.5% or more; or wherein a proportion of the mesopores based on total pores in the porous support is about 50% or more.
